(19) United States
(12) Patent Application Publication
(10) Pub. No.: US 2019/0036189 A1
(43) Pub. Date: Jan. 31, 2019

(54) A PHASE SHIFTER INCLUDING A BRANCHLINE COUPLER HAVING PHASE ADJUSTMENT SECTIONS FORMED BY CONNECTABLE CONDUCTIVE PADS

(71) Applicant: Raytheon Company, Waltham, MA (US)

(72) Inventors: Christopher M. Laighton, Boxborough, MA (US); Susan C. Trulli, Lexington, MA (US); Elicia K. Harper, Chelsea, MA (US)

(73) Assignee: Raytheon Company, Waltham, MA (US)

(21) Appl. No.: 15/659,877

(22) Filed: Jul. 26, 2017

(51) Int. Cl. H01P 1/18; H01P 11/00

(52) U.S. Cl. CPC H01P 1/184; H01P 11/00

(57) ABSTRACT

A phase shifter is formed by providing a branchline coupler having a pair of phase adjusting sections. Each one of the phase adjusting sections is coupled to a corresponding one of a pair of shunt transmission line sections of the branchline coupler. Each one of the pair of phase adjusting sections includes: first and second conductive pads are disposed on the surface of a substrate having a gap between them; one of the pads being connected to a ground plane conductor on a bottom surface of the substrate. A series of conductive layer segment is sequentially written on the surface of the substrate in the gap electrically connected to sidewalls of the first and second pads. Phase shift through the phase shifter is measured after each one of the segments is written. The writing process is terminated when the measuring detects a predetermined phase shift through the phase shift through the phase shifter.

This disclosure relates generally to analog phase shifters and more particularly to phase adjustable analog phase shifters.

### BACKGROUND

As is known in the art, one type of analog phase shifter includes a branchline coupler. One such branchline coupler, sometimes also referred to as a reflective coupler or a shunt hybrid combiner, is shown in FIG. 1 to include a pair of main transmission lines and a pair of shunt transmission lines. One analog phase shifter, (FIG. 2) that includes a branchline coupler is described in a paper entitled “Integral analysis of hybrid coupler semiconductor phase shifters” by Kori et al, IEE Proceedings, vol. 134, Pt.H. No. 2. April 1987.

One technique used to adjust phase shift of the branchline coupler type phase shifter is to connect a phase adjusting section connected to each one of the pair of shunt transmission lines as described in a paper entitled “A Low-Loss Voltage-Controlled Analog Phase-Shifter Using Branchline Coupler and Varactor Diodes” by Gupta et al., (Gupta, Nishant, Raghuvir Tomar, and Prakash Bhartia. “A low-loss voltage-controlled analog phase-shifter using branchline coupler and varactor diodes.” Microwave and Millimeter Wave Technology, 2007. ICMMT07. International Conference on. IEEE, 2007). There a pair of varactor diodes is controlled by voltages to adjust the phase shift provided by the phase shifter. Another branchline coupler type phase shifter having a phase adjusting section connected to each one of the pair of shunt transmission lines is shown in FIG. 3A. Here the phase adjusting sections each includes a pair of conductors separated one from and the other; one of the conductors being connected to a ground plane conductor on the bottom of a substrate. The two conductors are connected by a series of bridging, spaced bond wires, as shown. With an input signal applied, the phase at the output is measured and the bond wires are removed one at a time, as shown in FIG. 3B, to thereby change the electrical length of the path through the phase adjusting sections to ground until the desired phase shift is obtained; FIG. 3B showing several of the bond wires removed from the branchline coupler type phase shifter of FIG. 3A.

### SUMMARY

In accordance with present disclosure, a method is provided to forming a phase shifter, comprising providing a branchline coupler on an upper surface of a substrate with a pair of phase adjusting section, each one of the phase adjusting sections is coupled to a corresponding one of a pair of shunt transmission line sections of the branchline coupler. Each one of the pair of phase adjusting sections includes: a first conductive pad disposed on the upper surface of a substrate of the branchline coupler and is connected to the ground plane conductor on a bottom surface of the substrate. A second conductive pad is disposed on the upper surface of the substrate, the first conductive pad and the second conductive pad being separated by a gap. The method includes sequentially writing a series of conductive layer segment on the upper surface of the substrate in the gap electrically connected to sidewalls of the first conductive pad and the second conductive pad. Measuring phase shift through the phase shifter after each one of the segments is written. The writing process is terminated when the measuring detects a predetermined phase shift through the phase shifter.

With such method, the use of additive manufacturing (printing or writing) allows for fine levels of phase tuning.

In one embodiment, a phase shifter is provided having a branchline coupler; and a pair of phase adjusting sections, each one of the phase adjusting sections being coupled to a corresponding one of a pair of shunt transmission line sections of the branchline coupler, Each one of the pair of phase adjusting sections comprises; a first conductive pad disposed on the upper surface of a substrate of the branchline coupler and connected to a ground plane conductor on a bottom surface of the substrate; a second conductive pad disposed on the upper surface of the substrate, the first conductive pad and the second conductive pad being separated by a gap; and a conductive layer disposed on the upper surface of the substrate in the gap and having sidewalls electrically connected to sidewalls of the first conductive pad and the second conductive pad, such conductive layer having a length selected to provide a predetermined phase shift to a signal passing between the input port and the output port; the conductive layer being a material different from the first conductive pad and the second conductive pad.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is a schematic diagram of a branchline coupler according to the PRIOR ART;

FIG. 2 is a schematic diagram of a phase shifter using a branchline coupler according to the PRIOR ART;

FIGS. 3A and 3B are perspective views of a phase shifter using a branchline coupler according to the PRIOR ART at various stages in the fabrication thereof according to the PRIOR ART;

FIG. 4 is a perspective view sketch of a partially formed phase shifter at one stage in the fabrication thereof according to the disclosure;

FIGS. 5A and 5B are perspective view sketch of the partially formed phase shifter of FIG. 4 at two additional stages in the fabrication thereof according to the disclosure; and

FIG. 5C is a flow diagram of a process used to in the fabrication of FIGS. 4, 5A and 5B to form a completed phase shifter according to the disclosure.

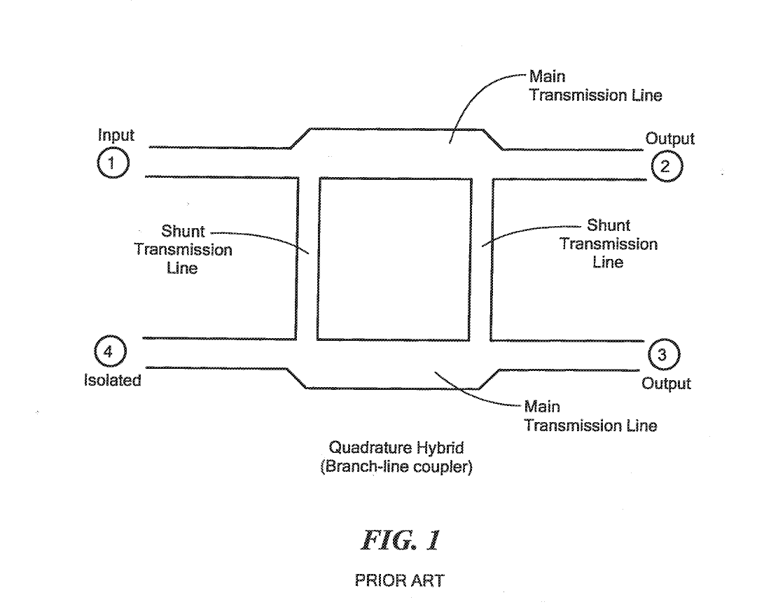

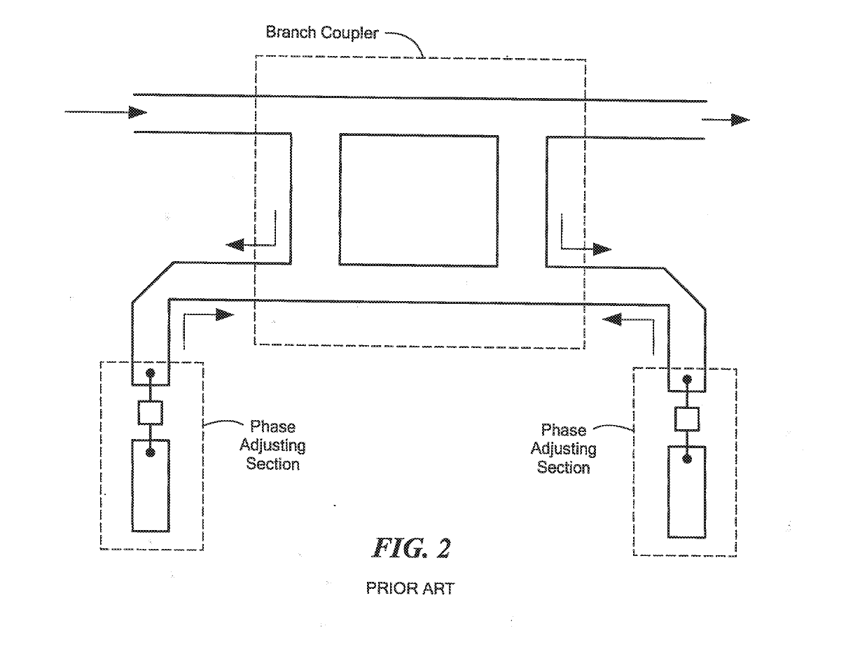

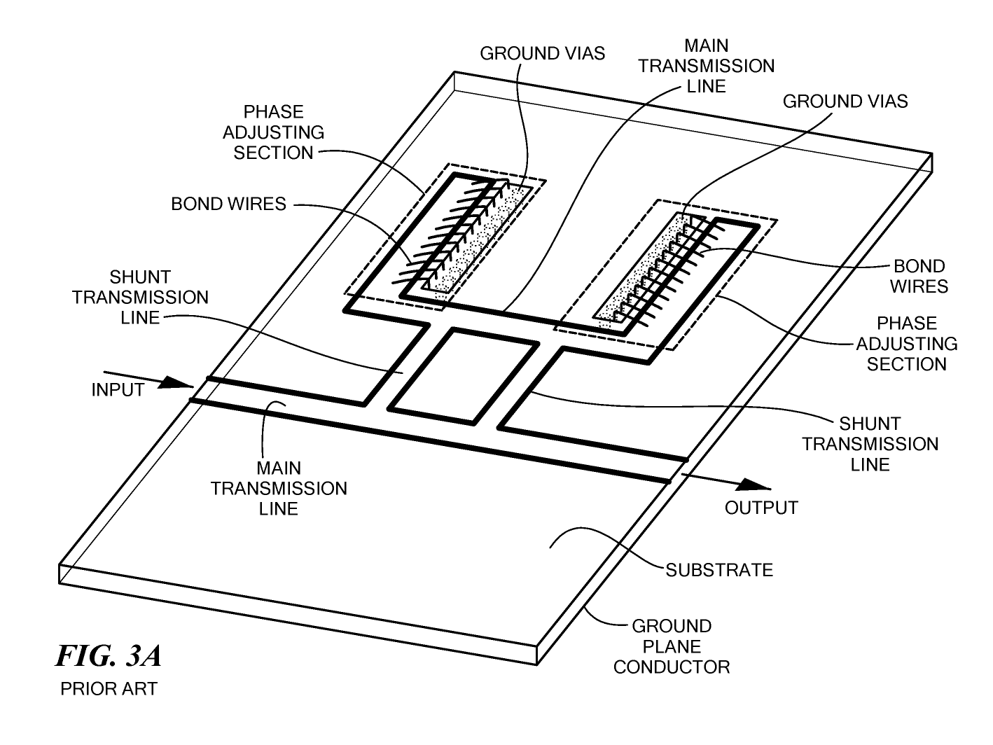

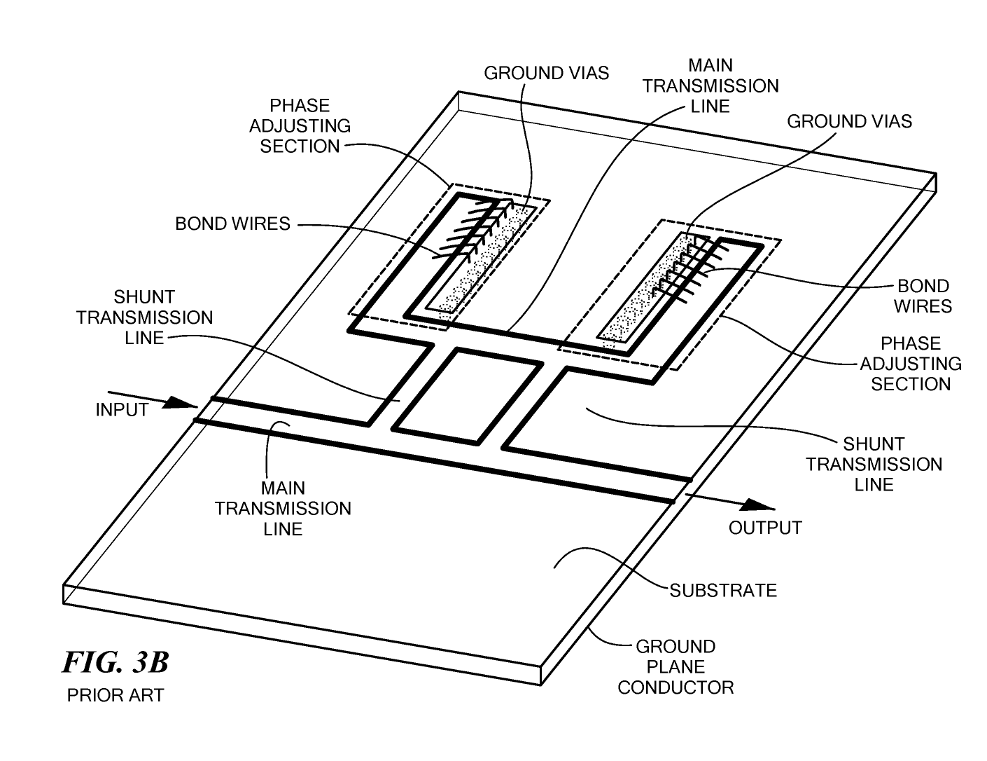

Like reference symbols in the various drawings indicate like elements.

### DETAILED DESCRIPTION

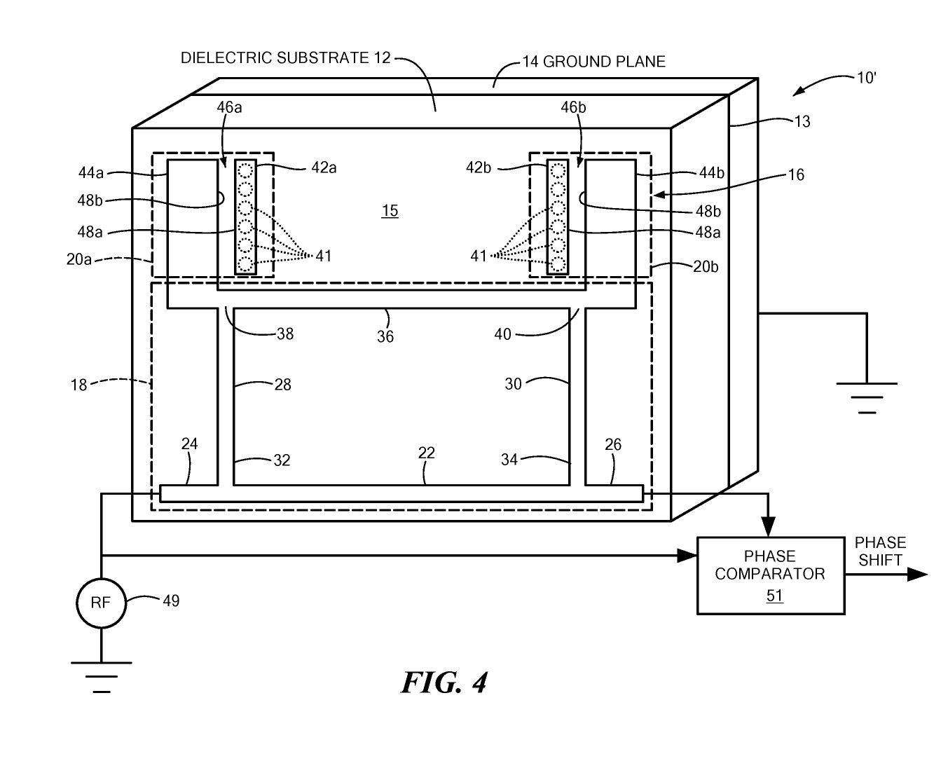

Referring now to FIG. 4, a partially complete phase shifter 10′ is shown having: a substrate 12 is provided having a ground plane conductor 14, here for example gold, on a bottom surface 13 of the substrate 12 and a lithographically-etched pattern of strip conductors 16, here for example gold, on an upper surface 15 of the substrate, as shown; the pattern strip conductors 16, substrate 12 and ground plane conductor 16 being arranged to form: a branchline coupler 18, here for example, a microstrip branchline coupler, connected to a pair of partially formed phase adjusting sections 20a, 20b, as shown. The branchline coupler includes: a first main transmission line 22 having an input end 24 and an output end 26; a pair of shunt transmission lines 28, 30, one, here shunt transmission line 28 having an input end 32 connected to the input end 24 of the first main transmission line 22 and the other, here shunt transmission line 30 having an input end 34 connected to the output end 26 of the first main transmission line 22; and a second main transmission line 36 coupled between output ends 38, 40 of the pair of shunt transmission lines. The pair of partially formed phase adjusting sections 20a, 20b are coupled to the output ends 38, 40, respectively, of a corresponding one of the pair of shunt transmission line sections 28, 30, respectively, as shown.

Each one of the pair of phase adjusting sections 20a, 20b comprises; a first conductive pad 42a, 42b, respectively, as shown, disposed on the upper surface 15 of the substrate 12 and connected to the ground plane conductor 14 through one or more electrically conductive vias 41 passing through the substrate 12; a second conductive pad 44a, 44b, respectively, as shown, disposed on the upper surface 15 of the substrate 12 and connected to the output ends 38, 40, respectively, of a corresponding one of the pair of shunt transmission line sections 28, 30, respectively, as shown. The first conductive pad 42a and the second conductive pad 44a have a gap 46a between them and the first conductive pad 42b and the second conductive pad 44b have a gap 46b between them, as shown.

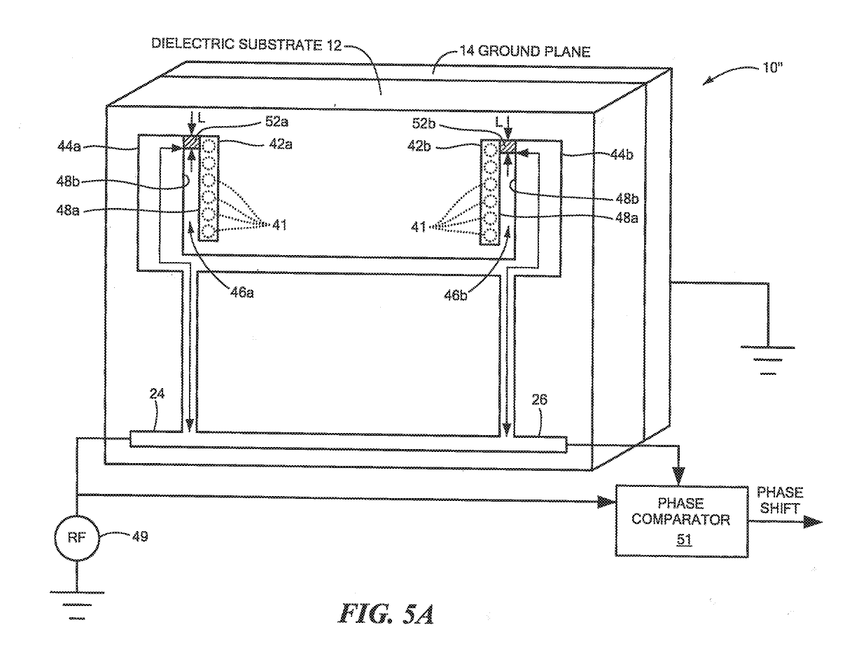

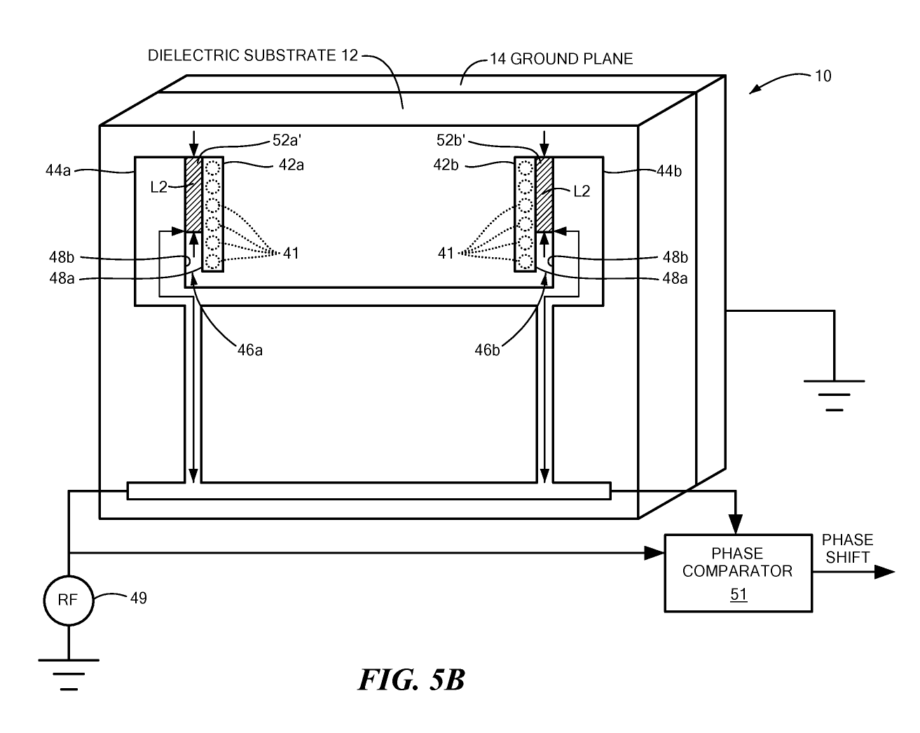

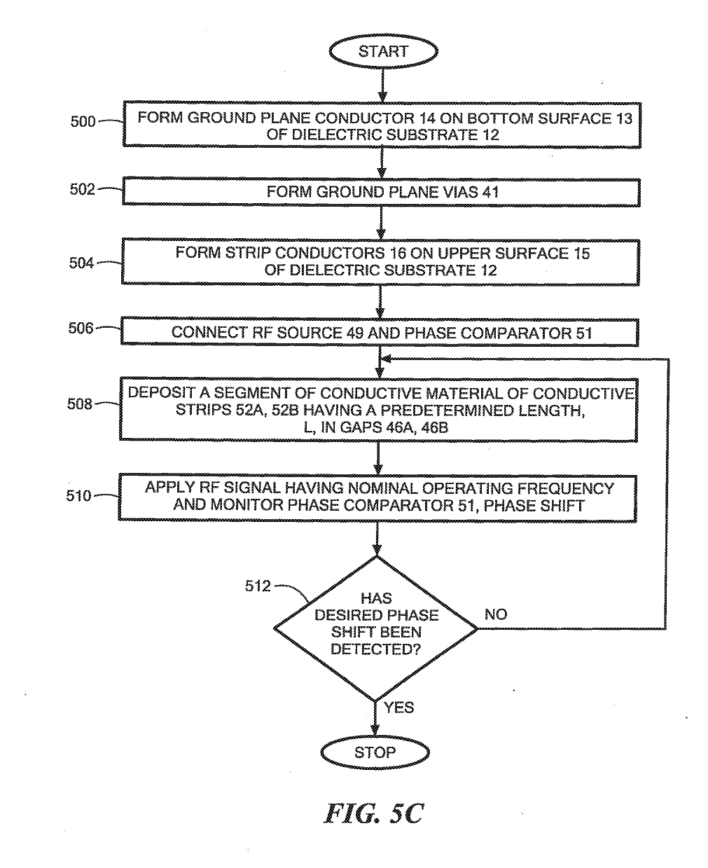

After providing the branchline coupler 18 and pair of partially formed phase adjusting sections 20a, 20b, as shown in FIG. 4, the partially formed phase adjusting sections 20a, 20b are completed in a process described below in connection with FIGS. 5A, 5B and 5C, suffice it to say here that conductive strips, or layers, 52a, 52b (FIGS. 5A and 5B), to be described, will be formed as conductive layers on the upper surface 15 of the substrate 12, using additive manufacture, such as 3D printing or other conductive material writing process, in the gaps 46a, 46b (FIG. 4) and on the opposing sidewalls 48a, 48b (FIG. 4) of pads 42a, 42b, respectively, and the opposing sidewalls 48a, 48b of pads, respectively; such strips having a length selected to provide a predetermined phase shift to a signal fed to input end 24 as such signal passing through the completed phase shifter 10 (FIG. 5B) to the output end 26. More particularly, to complete the phase shifter 10′ (FIG. 4) as will be described below in connection with FIGS. 5A, 5B and 5C the length of the conductive strip or layer 52a, 52b will have a length, L, L2 (FIGS. 5A and 5B) determined by a method to be described; suffice it to say here that the conductive layers or strips 52a, 52b (FIGS. 5A and 5B) will have a length, L, L2 selected to provide a predetermined phase shift to a signal passing between the input port or end 24 and the output port or end 26.

More particularly, and referring to FIGS. 5A, 5B and 5C, the method for completing the partially complete phase shifter 10′ includes the steps of: (a) forming the partially formed phase shifter 10′ (FIG. 5A), steps 500, 502, and 504 (FIG. 5C); connect an input signal from a source 49 step 506 and a phase comparator 51, step 506 (FIG. 506); (b) forming the conductive layers, or strips 52a, 52b by writing in the gaps 46a, 46b, a segment, of the conductive material, here for example, a conductive ink such as, for example Paru nanosilver PG-007, Paru, Co., Ltd Jeollanam-do, South Korea, on the upper surface 15 of the substrate 12 having a predetermined length, L, the conductive layer 52a, 52b segment being electrically connected to the opposing sidewalls 48a of pads 42a, 42b, respectively, and the opposing sidewalls 48b of pads 44a, 44b(FIG. 5B), step 508 (FIG. 5C); (c) apply input signal at input end or port 24 from source 49 having nominal operating frequency and measure the output signal at output end of port 26 with phase comparator 51, step 510, FIG. 5C; (d) determining whether the measured phase shift is the predetermined phase shift; if it is, the process stops and the phase shifter 10 is completed; if not, the process adds another segment of the conductive material having the predetermined length in the gaps 46a, 46b so that the length of the strips 52a, 52b are increased to strips 52a′, 52b′, now having a length an increased length, L2 (FIG. 5B), step 512 (FIG. 5C) and the process returns to step (d) (step 508 in FIG. 5C) until the measured phase shift is the predetermined phase shift thereby producing the completed phase shift 10, as shown in FIG. 5B where here, in this example, the lengths of the strips producing the predetermined phase shift are L2; it being understood that in a typical case the final length L2 may be much greater than L (FIG. 5A).

At microwave frequencies, the wire bond solution typically has granularity of 10-15 degrees per wire bond. However, using the additive manufacturing (writing or printing) described above, produces a much higher degree of granularity to the phase tuning capability of the shunt hybrid combiner technique. For example, segments having a length L of 2 mils create a 0.5 degree phase shift at upper C-Band frequencies. This compares to a 5-7 degree phase shift at C-Band frequencies from the above described prior wire bond solutions.

A number of embodiments of the disclosure have been described. Nevertheless, it will be understood that various modifications may be made without departing from the spirit and scope of the disclosure. For example, layouts and orientation may vary and still be within the spirit of the disclosure as well as the process of monitoring and adjusting the phase shift. Accordingly, other embodiments are within the scope of the following claims.

1. A method for forming a phase shifter, comprising:
providing a branchline coupler having a pair of phase adjusting sections, each one of the phase adjusting sections being coupled to a corresponding one of a pair of shunt transmission line sections of the branchline coupler, each one of the pair of phase adjusting sections comprising: first and second conductive pads disposed on an upper surface of a substrate, the first and second conductive pads having a gap there-between; one of the first and second conductive pads being connected to a ground plane conductor on a bottom surface of the substrate;
sequentially depositing in the gap a series of conductive layer segments on the upper surface of the substrate, the conductive layer segments being electrically connected to sidewalls of the first and second conductive pads;
measuring phase shift through the phase shifter after each one of the segments is deposited; and
terminating the depositing process when the measuring detects a predetermined phase shift through the phase shifter.

2. A phase shifter, comprising:
a branchline coupler;
a pair of phase adjusting sections, each one of the pair of phase shifting sections being coupled to a corresponding one of a pair of shunt transmission line sections of the branchline coupler, each one of the pair of phase adjusting sections comprising;
a first conductive pad disposed on the upper surface of a substrate of the branchline coupler and connected to a ground plane conductor on a bottom surface of the substrate;
a second conductive pad disposed on the upper surface of the substrate, the first conductive pad and the second conductive pad being separated by a gap; and
a conductive layer disposed on the upper surface of the substrate in the gap and having sidewalls electrically connected to sidewalls of the first conductive pad and the second conductive pad, such conductive layer having a length selected to provide a predetermined phase shift to a signal passing between an input port and an output port; the conductive layer being a material different from the first conductive pad and the second conductive pad.

3. A phase shifter, comprising:
a substrate having a ground plane conductor on a bottom surface thereof and strip conductors on an upper surface thereof, the strip conductors, substrate and ground plane conductor being arranged to form: a branchline coupler, comprising:
a main transmission line having an input end and an output end;
a pair of shunt transmission lines, one of the pair of shunt transmission lines having an input end connected to the input end of the main transmission line and the other of the pair of shunt transmission lines having an input end connected to the output end of the main transmission line;
an additional transmission line coupled between output ends of the pair of shunt transmission lines;
a pair of phase adjusting sections, each pair of phase shifting sections being coupled to the output end of a corresponding one of the pair of shunt transmission line sections, each one of the pair of phase adjusting sections comprising;
a first conductive pad disposed on the upper surface of the substrate and connected to the ground plane conductor;
a second conductive pad disposed on the upper surface of the substrate and connected to the output end of a corresponding one of the pair of shunt transmission line sections, the first conductive pad and the second conductive pad have a gap there-between; and
a conductive layer disposed on the upper surface of the substrate in the gap and having sidewalls electrically connected to sidewalls of the first conductive pad and the second conductive pad, such conductive layer having a length selected to provide a predetermined phase shift to a signal passing between the input end and the output end.

4. The method recited in claim 1 wherein the depositing comprises using additive manufacturing.
